(19) United States
(12) Patent Application Publication
(10) Pub. No.: US 2015/0252793 A1
(43) Pub. Date: Sep. 10, 2015

(54) POWER GENERATION

(71) Applicant: INTERLOCKING BUILDINGS PTY LTD, Melbourne, Victoria (AU)

(72) Inventor: Geoffrey Alan Croker, Ashwood (AU)

(73) Assignee: INTERLOCKING BUILDINGS PTY LTD, Melbourne, Victoria (AU)

(21) Appl. No.: 14/423,886

(22) PCT Filed: Aug. 15, 2013
(86) PCT No.: PCT/AU2013/000894

§ 371 Date: Feb. 25, 2015

(30) Foreign Application Priority Data
Aug. 29, 2012 (AU) 2012903732

(51) Int. Cl. F03G 7/04; F01D 15/10; F03B 13/08

(52) U.S. Cl. CPC F03G 7/04; F03B 13/08; F01D 15/10; F05B 2210/11

(57) ABSTRACT

A method of driving an apparatus, comprising, piping water derived from an underwater seep under such conditions that the piped water is arranged to flow under its own pressure to the apparatus to drive the apparatus.

### FIELD OF THE INVENTION

The present invention relates to an apparatus and method for converting potential energy stored as water under pressure in submarine aquifers and converting that energy to kinetic and/or electrical energy.

### BACKGROUND OF THE INVENTION

Submarine aquifer discharge is a common, naturally occurring feature along most coastlines, lakes and rivers. It also occurs in deep ocean waters.

Typically, aquifer discharge comprises freshwater flowing into sea water. If flows are large enough a “pool” of freshwater appears on the sea water surface. Flowing freshwater is not easily mixed with salt water.

Aquifers are porous, permeable layers of sediments such as sandstone, silt or limestone, sandwiched between non-permeable rock and clays. They are fed by rainfall from the land or supplied from a source rock and may be confined or unconfined.

Aquifers that occur in sediment under bodies of sea water, can be connected to that sea water, by natural features such as faults, volcanic action, physical or chemical erosion, earthquakes, glacial activity, sea level movement, sedimentation etc. Water is forced by gravity from the aquifer into the lake or ocean above it. The aquifer is “squeezed” by the overburden and water rises where possible.

Aquifers may be connected to a local coastline following an old river bed, seabed or flood plain, or confined within older sediments at great depth. Typically this happens during times of lower ocean depths such as an active glacial period or ice age. As the glaciers recede the freshwater in rivers becomes confined in a sedimentary aquifer under the ocean.

This also occurs in very deep water. Trapped water in a confined aquifer can be millions of years old before it finally is naturally exposed and leaks under great pressure. The velocity of escaping leakage is reduced by friction. However, the pressure is generally maintained.

What each aquifer type has in common is some naturally occurring discharge area from the ocean or lake floor. This leakage may occur over a small or very large area. Large volume, small area, leakage points are often well known and may appear as “named” features on ocean charts.

The potential energy contained in a submarine aquifer is significant. Friction reduces the discharge velocity as it flows through permeable sediments to the sea or lake, floor. By diverting the aquifer discharge flow into a specially shaped membrane connected to an exit pipeline, water can be accelerated to a much higher velocity.

This potential energy may be harvested with little or no emission of pollutants or carbon dioxide.

Where the discharge water quality is suitable, it can also provide a huge source of untapped irrigation or drinking water.

Large flows can often be seen on the ocean or lake surface with the naked eye. Most often the discharge is of a different temperature and the discharge flow area can be detected using satellite or aircraft with infra-red photography. Such flows are usually many thousands of years old, and may even be millions of years old.

The suitability of a seep can be easily assessed by using well known measuring techniques used by hydro-geologists and oceanographers. Such techniques are used to obtain the flow rate, discharge quality and age, ocean or lake depth, location of required piping etc.

### DISCLOSURE OF THE INVENTION

The invention provides a method of driving an apparatus, comprising, piping water derived from an underwater seep under such conditions that the piped water is arranged to flow under its own pressure to the apparatus to drive the apparatus.

By saying that the piped water is arranged to flow under its own pressure, we mean pressure resulting from the difference in density of saline water overlying the seep and the density of the water emanating from the seep, plus pressure if any of water emanating from the underwater seep. Generally speaking, it is expected that the major difference in density will be caused by the difference in salinity of the overlying water and the water from the seep. However, other factors such as temperature differences may also come into play.

Seeps which flow with aged water, are likely to substantially maintain their flow rate even in times of drought, as the water may have been deposited many years before the drought occurred. In choosing seeps, it is preferable to perform the invention in relation to seeps which are likely to maintain their water flow ie. choosing seeps with water which is aged will generally be preferred. Typically one would prefer to have seeps supplying water which is aged by at least 5 years, more preferably 10 or 20 years.

The apparatus of the invention is most suitably used to generate electricity, although it is to be appreciated that the energy supplied by the piped water can be used to drive mechanical arrangements other than electricity generating apparatus.

After water from the seep has been used to drive the apparatus, it may be returned to a marine environment or alternatively, it may be sent to a storage reservoir for purposes such as irrigation or drinking water.

The water from the seep may be collected under a flexible diaphragm. The flexible diaphragm may be arranged so that it has a broader end covering the seep. The diaphragm may taper to a narrower opening for an offtake pipe. The offtake pipe may also be formed of a flexible material.

The flexible material used to collect water from the seep to direct it to the offtake pipe may suitably be formed in the shape of a generally conical member with the base of the cone sitting against the floor of an ocean or lake in communication with the seep. The edges of the cone may be covered with material to hold the cone down. Suitable material may comprise aggregate and/or rocks.

A float may be used to hold the top of the cone upright. It may be connected to the top of the cone by a cable and may be arranged to sit below the surface of the overlying water by a distance which is chosen having regard to disturbance by wave action on the surface. The depth of the float may vary between different environments. However, in most circumstances, it is expected that ensuring that the float remains 10 metres below the surface more preferably 12 metres will suffice. In this way it should be possible to reduce disturbance by wave action.

The surface of the diaphragm forming the cone may be treated with a material resistant to being fouled by marine flora and fauna or it may itself be resistant in this regard. It has been found that polymeric materials are generally resistant in such circumstances. The flexible piping material may also be treated in the same fashion.

The cone may be reinforced by a plurality of battens. Battens may also be used to reinforce the flexible pipe.

Electricity may be generated by using conventional means such as a pelton wheel and/or francis turbine driving a generator or alternator.

As it is anticipated that the major driving force for the piped water will be the difference in density between the water emanating from the seep and surrounding water, it is preferred that saline content of the surrounding water be at least 50% of the average salt content of the earth's oceans. Of course, the greater the difference in density, the greater pressure exerted per metre of depth on the emanating seep water.

Where the seep is located in an ocean, given the difference in density between fresh water and the saline water, the depth of the seep below the surface of the saline water should preferably be at least 15 metres.

Where there is more than one seep in a region, or where a single seep covers a large area, multiple cones or other collecting members may be used to collect water from the seep. Water from the multiple collecting members may be joined in series or in parallel and may be sent off to one or more systems for driving electrical generating apparatus.

### BRIEF DESCRIPTION OF THE DRAWINGS

FIG. 1 illustrates a schematic view of a construction according to the invention;

FIG. 2 shows a schematic view of an arrangement for collecting water from a seep;

FIGS. 3A, 3B and 3C show outlines of typical membrane shapes for collecting water from a seep;

FIG. 4 shows a schematic view of more than one collection point for a seep; and

FIG. 5 shows schematically steps taken in erecting a seep collection point.

The various elements identified by numerals in the drawings are listed in the following integer list.

### INTEGER LIST

1 Generating system
3 Conical collecting member
4 Base
5 Sea floor
6 Upper portion
7 Sloping floor
9 Shore
11 Float
12 Cable
13 Seep
15 Water flow
17 Surface
19 Relief valve
21 Join
23 Flexible pipe
25 Solid pipe
27 Electrical generator
29 Offtake pipe
31 Aggregate
33 Conical collecting member
35 Circular base
37 Apex
39 Batten
40 Offtake water
41 Conical member
43 Square base
45 Offtake water
47 Collecting member
49 Offtake water
51 Multiple system
53 Conical member
54 Seep water
55 Flexible pipe
57 Flexible membrane
59 Pole
61 Float
63 Surface
65 Seep water flow
67 Weight
69 Wire
71 Weight
73 Wire
75 Relief valve
77 Cable
79 Offtake pipe
81 Pulley

### DETAILED DESCRIPTION OF THE PREFERRED EMBODIMENTS

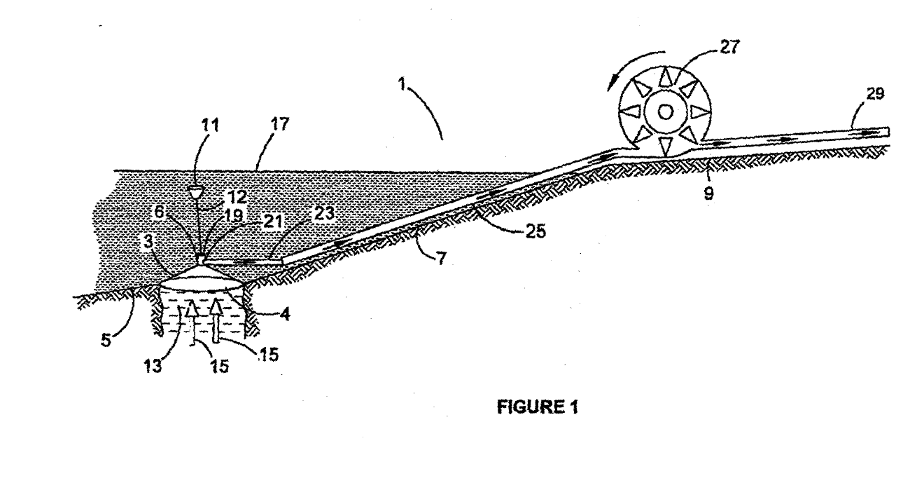

Referring to FIG. 1, there is shown a generating system for generating electricity which is indicated by the reference numeral 1.

The generating system 1 comprises a conical member 3 made of a flexible material such as polyethylene or polypropylene or even carbon fibre. It may be a woven or sheet material. If the flexible material is prone to be fouled by marine organisms, it is preferred that at least the outer surface of the flexible material be covered by an anti-fouling agent or a material which resists fouling such as polyethylene.

The base 4 of the conical member 3 sits on the sea floor 5 and will be held down by appropriate means some of which are described hereinafter. The base 4 sits over a seep 13 from which there is a water flow 15. The upper portion 6 of the conical member 3 is provided with a join 21 connecting the narrower end of the conical member to a flexible pipe 23. The flexible pipe may be made of any material which may be sufficiently strong to resist the pressure of water inside the flexible pipe and it may also incorporate or be composed of a material which resists fouling by marine organisms. It may be formed of the same material as the material forming the conical member.

A float 11 joined by a cable 12 to a relief valve 19 provided at the top of the conical member holds the conical member upright at a level beneath the surface 17 of the sea. In this way, it is possible to maintain the top of the conical member at a depth below which it is not likely to be unduly disturbed by ocean waves.

A solid pipe 25 joined to the end of the flexible pipe 23 at a region where the flexible pipe abuts the sloping floor of the sea floor sits along the sloping floor and directs water flowing through the pipe to the shore 9.

An electrical generator 27 sitting on the shore 9 is driven by water from the pipe 25. An offtake pipe 29 takes water exiting the electrical generator and returns it to the sea or pipes it for ongoing use such as irrigation or domestic use.

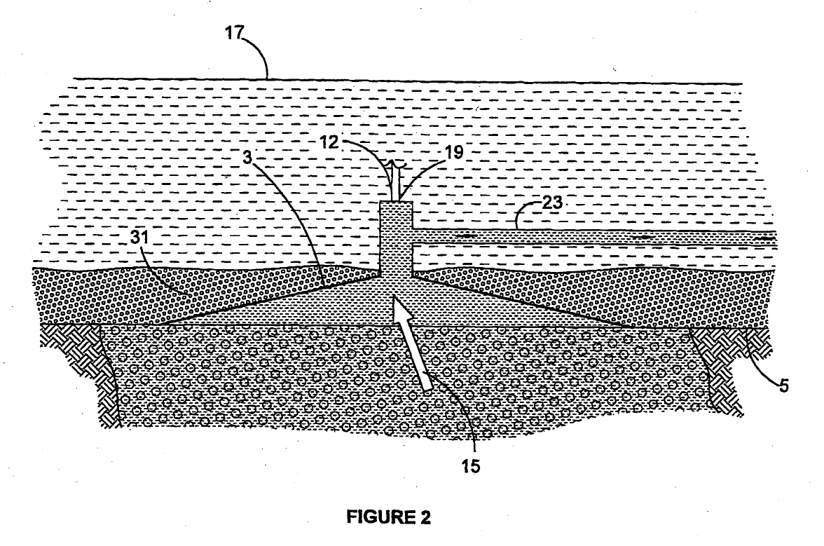

In FIG. 2, it can be seen that the conical member 3 has its edges covered by an aggregate 31 to hold the conical member down on the sea floor in a manner that the water flow 15 from the seep is not in communication with the water of the sea. In such an arrangement, any pressure inherent in the water flow 15 is additive to the pressure derived from the difference in density between the water flow 15 and the sea water.

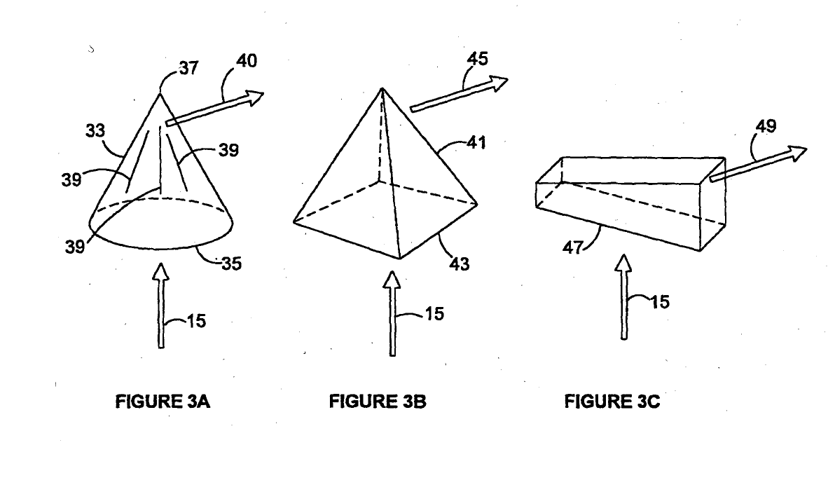

In FIG. 3A, it can be seen that the conical collecting member having a circular base 35 and an apex 37 is reinforced with battens 39. Offtake water 40 is bled off from near the apex of the conical collecting member 33 as per the description with reference to FIG. 1.

In FIG. 3B, the conical member 41 has a square base 43. It may also optionally be reinforced with battens and offtake water 45 is again taken near the apex of the conical member.

The collecting member 47 shown with reference to FIG. 3C shows that a range of alternative shapes of collecting members may be used provided that offtake water 49 is taken from a high point along the collecting member and provided the cross-sectional area of the connection for taking the offtake water 49 is less than the cross-sectional area of the seep over which the collecting member is placed. This is to ensure that there is sufficient water flow and pressure to drive machinery which is piped from the seep. It is to be appreciated that all types of different shapes and sizes of collecting member may be used depending upon the particular dimensions of the seep, the depth of the water, topography and rate of water flow.

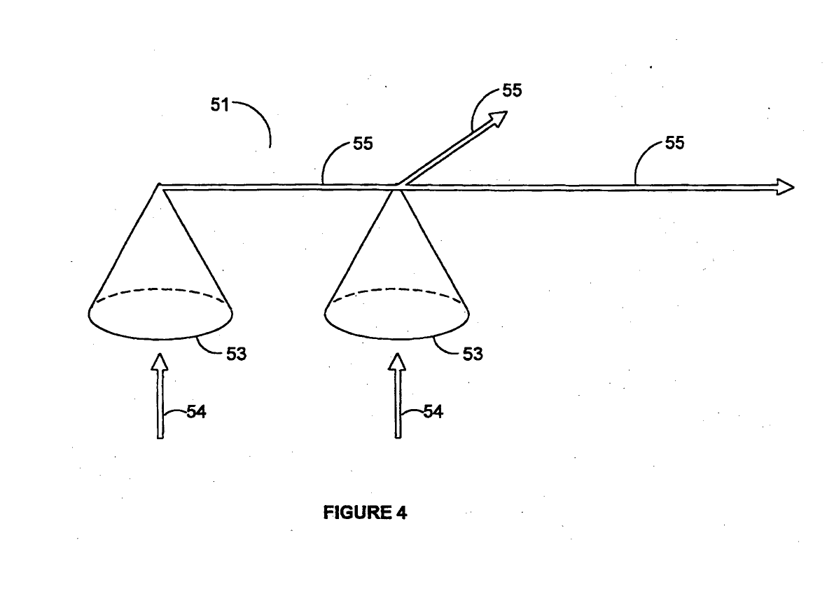

In this regard, referring to FIG. 4, which shows a multiple system generally designated 51, it can be seen that two or more collecting members such as the two conical members 53 may be placed over one or more seeps providing seep water 54 and may be joined in series by flexible pipes 55 which can direct water from the seep to one or more locations. Whilst the illustration in FIG. 4 shows two collecting members 53 in series, it is to be appreciated that, series, parallel and combination series/parallel systems may also be employed.

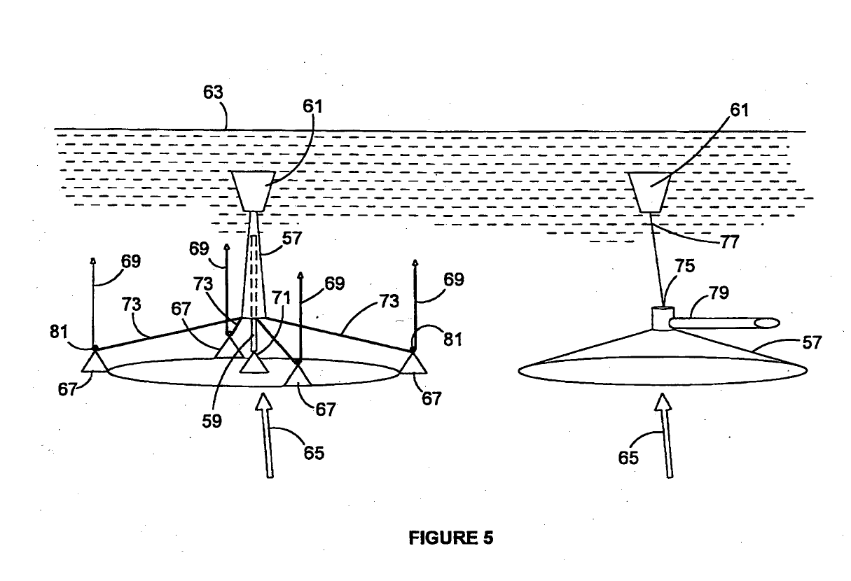

Referring to FIG. 5, the illustration on the left hand of FIG. 5 shows one of the first stages of deployment of a conical member over a seep water flow 65 prior to the conical member being fully erected.

Initially, a flexible membrane 57 wrapped on a pole 59 is suspended beneath the ocean surface 63 by a float 61. The pole 59 is held down by a weight 71 and wires 73 secure the bottom of the, flexible membrane, to a plurality of weights 67. The wires 73 extend under pulleys 81 and extend upwardly as wires 69 to one or more vessels on the surface 63 of the water during deployment. By pulling on wires 69, the flexible membrane is extended to the conical shape shown on the right side of the drawing of FIG. 5. A cable 77 extends into and attaches to the relief valve. The float 61 suspends the top of the flexible membrane 57 at a predetermined depth and maintains it in a conical shape. Subsequently, the offtake pipe 79 may be fitted to the top of the conical member in the region of the pressure relief valve and aggregate may be placed over the edges of the bottom of the conical member to hold it on to the ocean floor.

Whilst the above description includes the preferred embodiments of the invention, it is to be understood that many variations, alterations, modifications and/or additions may be introduced into the constructions and arrangements of parts previously described without departing from the essential features or the spirit or ambit of the invention.

It will be also understood that where the word “comprise”, and variations such as “comprises” and “comprising”, are used in this specification, unless the context requires otherwise such use is intended to imply the inclusion of a stated feature or features but is not to be taken as excluding the presence of other feature or features.

The reference to any prior art in this specification is not, and should not be taken as, an acknowledgment or any form of suggestion that such prior art forms part of the common general knowledge.

1. A method of driving an apparatus, comprising, piping water derived from an underwater seep under such conditions that the piped water is arranged to flow under its own pressure to the apparatus to drive the apparatus.

2. The method according to claim 1 wherein the apparatus is used to generate electricity.

3. The method according to claim 1 wherein the seep is located under saline water having a salt content at least 50% of the average salt content of the earth's oceans.

4. The method according to claim 3 wherein the seep is located at least 15 meters beneath the surface of the saline water.

5. The method according to claim 1 wherein the broader end of a collecting member is placed over the seep to collect water from the seep and to pipe it through a join provided at a region of the collecting member which is narrower than the broad end to an offtake pipe.

6. The method according to claim 5 wherein the collecting member comprises a flexible generally cone shaped diaphragm formed of a material resistant to being fouled by marine flora and fauna, and the broader end of the collecting member is secured to ground surrounding the seep so as to substantially prevent communication between water from the seep and the saline water.

7. The method according to claim 5 wherein the collecting member is suspended beneath the surface of the saline water by a float, such that the join lies at least 7 meters below the surface.

8. The method according to claim 6 wherein the collecting member is reinforced by a plurality of battens and the surface of the collecting member exposed to saline water comprises polymeric material.

9. The method according to claim 2 wherein the apparatus comprises at least one of a pelton wheel and a francis turbine.

10. The method according to claim 1 wherein the piped water is directed to storage after driving the apparatus.

11. The method according to claim 8 wherein at least one of rocks and gravel are used to cover the broader end of the collecting member whereby to hold it down.

12. A construction for generating electricity comprising,
a generally conical member,
an offtake pipe from the conical member, and
generating apparatus operable by water flow joined to the offtake pipe,
wherein the conical member is secured with its broader end in communication with a seep located beneath external overlying water of an ocean, or a saline lake having a salt content at least 50% of the average salt content of the earth's oceans, and the depth of the seep is chosen to provide that the difference in density between seep water emanating from the seep and overlying water is sufficient to cause seep water to flow through the offtake pipe at a sufficient rate and pressure as to drive the electrical generating apparatus.

13. The construction according to claim 12 wherein the conical member and offtake pipe comprise a flexible membrane whose outer surface comprises a polymeric material.

14. The construction according to claim 12 wherein the electrical generating apparatus comprises at least one of a pelton wheel and a francis turbine.

15. The construction according to claim 12 wherein a plurality of battens are provided to stiffen the flexible membrane of the conical member.

16. The construction according to claim 12 wherein the conical member is suspended beneath the overlying water by a float.
